(19) United States
(12) Patent Application Publication
(10) Pub. No.: US 2025/0173592 A1
(43) Pub. Date: May 29, 2025

(54) Integrated Intelligence Platform for Data-Driven Climate Action

(71) Applicant: Soumit Roy, Aurora, IL (US)

(72) Inventor: Soumit Roy, Aurora, IL (US)

(21) Appl. No.: 18/519,108

(22) Filed: Nov. 27, 2023

(51) Int. Cl. G06N 5/046

(52) U.S. Cl. CPC G06N 5/046

(57) ABSTRACT

The present invention relates to an integrated platform to drive climate change mitigation through advanced data analytics and prediction-based policy activation. The system consolidates siloed emissions data from diverse sources into a unified structure for in-depth analysis using artificial intelligence and machine learning techniques. Sophisticated modeling predicts expected temperature changes, extreme weather events, and evolving emissions patterns. Interactive dashboards clearly visualize these predictions to activate targeted sustainability policies and outcomes. Built-in workflow tools enable administrators to instantly translate predictive insights into optimized climate response plans. Designed for flexibility, the cloud-agnostic architecture readily integrates with existing technology stacks for easy adoption. By breaking down data silos to generate actionable intelligence, this invention provides a comprehensive solution to understand complex climate threats and respond with evidence-based actions to create a sustainable future. The platform ultimately enables data-driven climate governance through unprecedented integration of real-time emissions data sources, predictive analytics, and policy activation.

### FIELD OF INVENTION

The present invention relates to systems and methods for climate change monitoring, analysis, and governance through the application of data aggregation, machine learning, predictive analytics, and policy activation. More specifically, the invention pertains to an integrated platform for ingesting diverse environmental data sources, leveraging artificial intelligence to generate actionable insights, and translating predictive intelligence into tangible sustainability policies, regulations, and outcomes.

### BACKGROUND OF THE INVENTION

Global warming caused by rising greenhouse gas emissions poses a critical threat, requiring urgent climate action. Current solutions focus on siloed carbon footprint tracking, lacking integrated data analysis and coordination. Most are also locked into specific cloud platforms, limiting flexibility. This invention presents a comprehensive framework to enable sustainable climate control through effective utilization of climate data.

The cause of the problem is increasing greenhouse gas emissions, primarily carbon dioxide, from human activities like fossil fuel usage. This greenhouse effect amplifies the natural warming of the atmosphere, causing worldwide temperature rises, extreme weather, and other climate impacts. While the science is clear, implementing integrated solutions across cities, states, and countries remains challenging.

Existing approaches emphasize tracking emissions, but in isolated ways without larger synthesis. Some utilize artificial intelligence to manage urban carbon footprints. However, they are constrained to particular cloud platforms, which restricts broader adoption. Cities and states may also lack the budgets for required subscriptions. Crucially, siloed tracking fails to provide integrated analytics combining diverse data sources. This limits the ability to coordinate climate action across all levels of government.

This invention aims to overcome these limitations through an end-to-end framework leveraging data engineering, analytics, and artificial intelligence. The objective is a sustainable climate control solution using technology to harness the full potential of climate data. This entails consolidating data from myriad sources into a unified structure for in-depth analysis. Advanced modeling then enables predictive insights to guide tangible actions through interactive dashboards, policy tracking, alerts, and more.

The iterative approach continually refines the system to enhance predictive capabilities over time. Tight integration also connects cities, states, counties, and countries to align climate initiatives. With flexible and scalable architecture, the solution can support diverse use cases across the public and private sectors. Overall, this invention represents a novel application of data science and AI to drive impactful sustainability outcomes. Moving beyond siloed data, it provides the integrated toolkit needed to understand complex climate factors and respond with evidence-based solutions.

### SUMMARY OF THE INVENTION

The following summary is an explanation of some of the general inventive steps for the device and apparatus in the description. This summary is not an extensive overview of the invention and does not intend to limit its scope beyond what is described and claimed as a summary.

In some embodiments thereof, the present invention presents an integrated platform to enable data-driven climate action through advanced data consolidation, analytics, and policy activation. It aims to overcome current limitations of isolated, siloed emissions tracking by providing a holistic framework to harness the full potential of diverse climate data sources.

In one non-limiting aspect, the platform first ingests varied data streams from sensors, IoT devices, legacy databases and more into a unified structure. Robust ETL processes extract, transform and load the heterogeneous data for standardization. This integrated repository provides a single source of truth combining real-time and historical emissions data across multiple domains.

In another aspect, adaptive and trained artificial intelligence and machine learning techniques are then applied to the consolidated data corpus to deliver predictive insights. The system models complex climate phenomena to forecast expected temperature changes, extreme weather events, changing emissions patterns, and more. These AI models continuously improve their accuracy through recursive training and validation.

In yet another aspect, predictive intelligence is seamlessly translated into clear recommended actions to drive sustainability policies and outcomes. Interactive dashboards present model outputs through compelling visualizations, alerts highlight critical threats, and built-in policy workflow tools activate regulation scenarios. This empowers administrators with the actionable plan needed to mitigate high-risk climate impacts.

Designed for flexibility, the invention provides a platform that readily may integrate existing technology stacks through open APIs and microservices. The multi-tier architecture allows efficient scaling to accommodate growing data volumes. Cloud-agnostic implementation prevents vendor lock-in. Overall, this invention enables hitherto siloed climate data to become an integrated asset for governments and communities worldwide to understand, predict, and act decisively to create a sustainable future.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 is an illustration of the invention's operation layers according to one aspect.

FIG. 2 shows an operation model according to one aspect.

FIG. 3 is an operation process according to one aspect.

FIG. 4 shows a process to achieve sustainable control according to one aspect.

FIG. 5 is a universal adapter design according to one aspect.

FIG. 6 demonstrates a four-quadrant model according to one aspect.

### DETAILED DESCRIPTION OF THE PREFERRED EMBODIMENTS

Hereinafter, the preferred embodiment of the present invention will be described in detail and reference made to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

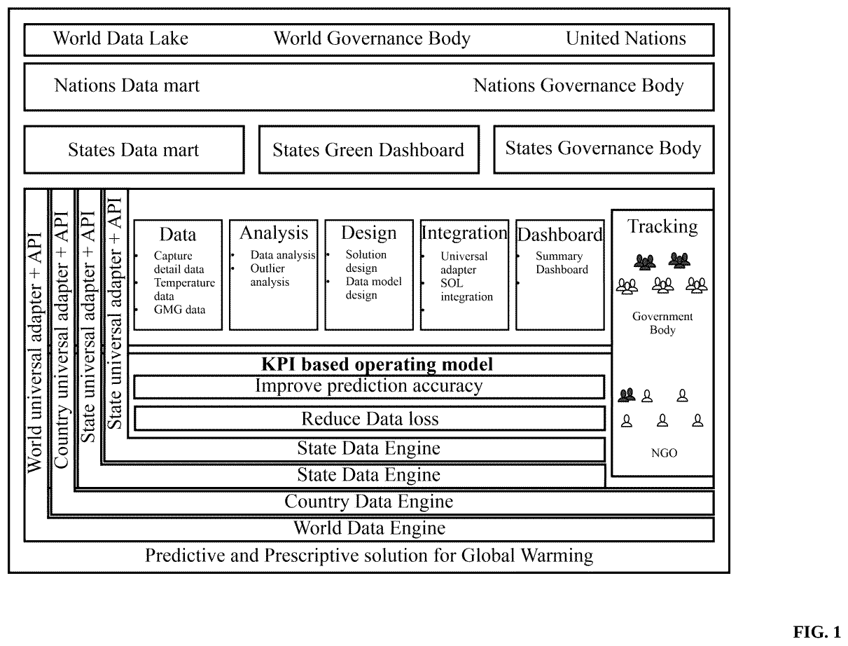

In accordance with one embodiment, FIG. 1 illustrates the intricate multi-layered architecture of a cutting-edge system designed to revolutionize climate governance. This integrated climate data analytics and policy activation system represents a paradigm shift in addressing the challenges of global climate change. The overarching goal is to facilitate sustainable climate governance through a systematic framework that encompasses the ingestion of diverse climate data sources, seamless integration of this data into a unified structure, application of intelligent analytics for actionable insights, and the activation of targeted policies and interventions.

The foundation of the system lies in the diverse array of data sources, including emission data, temperature readings, and other climate-related datasets collected globally from countries, cities, sensor networks, satellites, and more. The inherent challenge is the heterogeneity of these datasets in terms of format, structure, and provenance. To unlock their value, a crucial first step is the transformation of this data into a consistent schema.

The data acquisition layer addresses this challenge through a robust extract, transform, load (ETL) process. Leveraging standard ETL techniques, it ingests data from disparate sources, cleanses and processes it into standardized formats, and loads it into staging repositories. This layer incorporates schema normalization and quality checks to overcome the diversity of the source data, enabling the consolidation of massive volumes of structured and unstructured climate data for further unified analysis.

Building on the normalized datasets, the data integration layer assembles them into a consolidated data repository. Through the use of APIs, adapters, and mapping functions, it amalgamates the various data streams into a cohesive whole. The resulting integrated data lake offers a comprehensive 360-degree view of global climate factors, combining historical archives and real-time data feeds in one centralized location. This unified structure ensures alignment and interoperability across the domain.

With the integrated data foundation in place, the analytics layer comes into play, applying state-of-the-art artificial intelligence algorithms, predictive models, and analytical techniques to derive actionable insights. This encompasses forecasting expected temperature changes and emission trends based on current trajectories, with continuous recalibration of projections as new data arrives. Key performance indicators are calculated to quantify sustainability metrics and climate impact. Predictions are reconciled with actual measurements, triggering alerts when thresholds are exceeded.

The final layer, the action layer, translates the insights garnered through advanced analytics into real-world climate policies and interventions. Interactive dashboards visually communicate insights to decision-makers, while scenario analysis tools assess potential regulatory outcomes before implementation. Automated policy workflows activate response plans to mitigate high-risk climate threats, and notifications recommend interventions to relevant authorities and stakeholders. This approach enables data-driven decision-making for evidence-based climate action.

This multi-layered architecture provides end-to-end orchestration, seamlessly guiding the transformation from raw climate data to decision support. Each layer builds upon the previous, enabling accurate data gathering, structured aggregation, in-depth analysis, and, ultimately, the targeted activation of sustainability policies through a technology-enabled, integrated intelligence platform. This innovative system delivers a comprehensive solution to manage climate data and respond with systematic, measurable, and high-impact policies for real-world change. It stands as a testament to the transformative potential of technology in addressing the pressing challenges of global climate change.

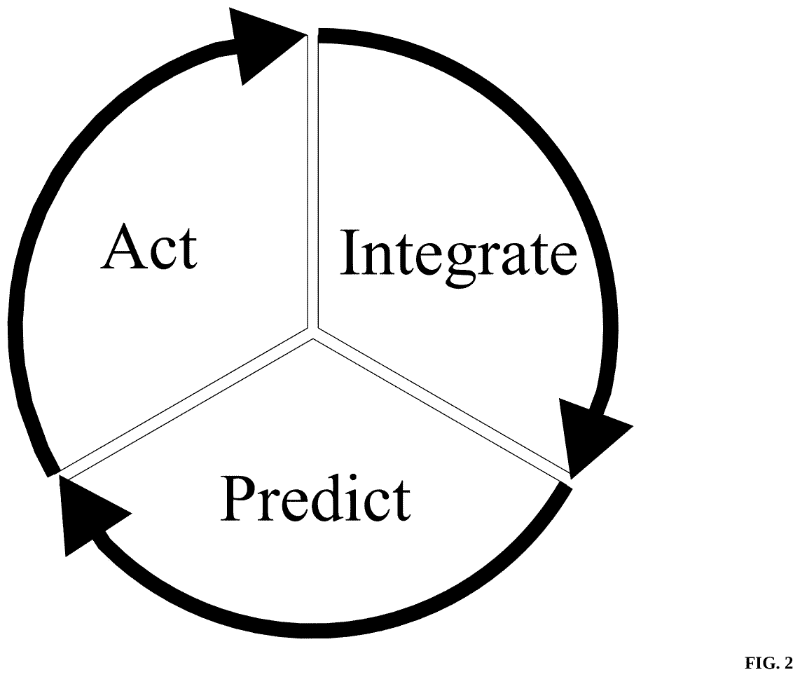

The non-limiting embodiment according to FIG. 2 illustrates an operation model according to one embodiment that follows an IPA (Integrate, Predict, Act) cycle for climate data processing and action. The iterative approach continually improves climate intelligence and response.

First, the Integrate phase consolidates heterogeneous climate data from disparate sources into a unified structure. Data ingestion workflows pull in emissions data, temperature readings, and other environmental metrics from sensors, satellites, legacy repositories and more. Robust ETL (extract, transform, load) processes clean, standardize, and integrate the varied data feeds into a cohesive data repository.

Next, the Predict phase applies analytics and machine learning algorithms to the integrated data corpus to generate actionable insights. AI models identify trends and patterns to forecast expected emissions, temperature changes, extreme weather events, and other climate impacts. Predictive analytics quantify sustainability KPIs for tracking.

The Act phase then activates tangible climate policies and interventions based on the predictive intelligence uncovered in the data. Interactive visualizations communicate insights to decision makers to inform policymaking. Scenario analysis evaluates potential regulations for effectiveness. Automated workflows trigger response plans to mitigate high-risk climate threats.

Finally, the cycle repeats with the integrated data foundation continually refreshed with new data. Regular reconciliation compares previous predictions to actual metrics, tuning the models for increased accuracy over time. Each iteration refines the integration, predictions, and actions for optimized climate response.

In some aspects, the closed-loop IPA demonstrated by FIG. 2 approach enables the system to ingest real-time climate data, apply analytical models to gain insights, activate policies, monitor outcomes, and re-tune—enabling continuous improvement. The integrated platform provides a framework for technology-enabled climate governance based on systematic data-driven decision making. Overall, this iterative operation model represents a robust architecture for harnessing climate data to drive meaningful sustainability action.

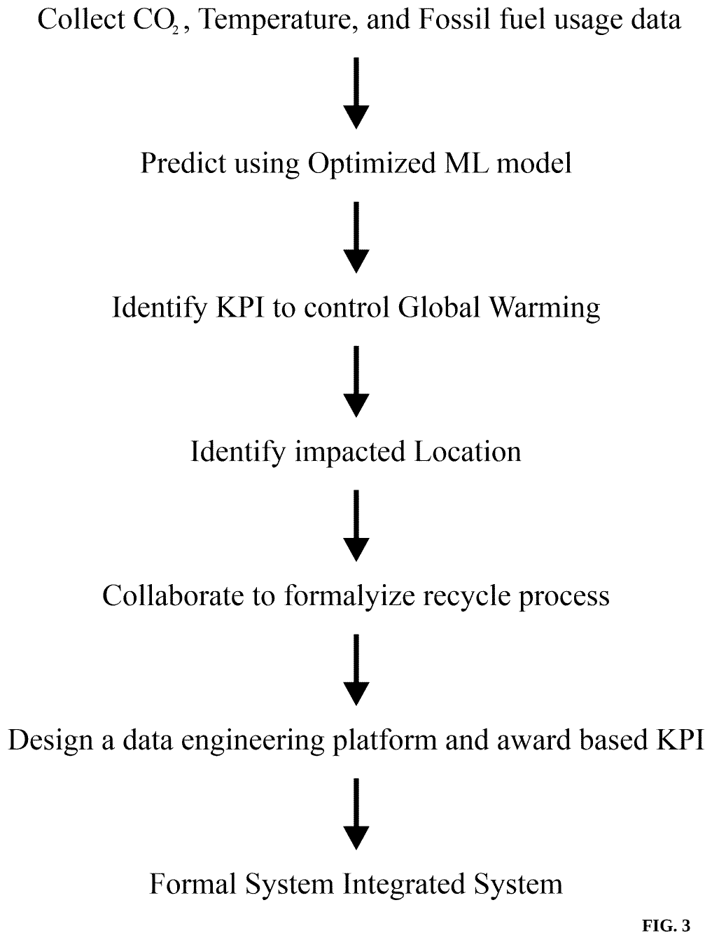

Further, in an embodiment according to FIG. 3, it is illustrated the detailed operation process for the integrated climate data analytics and policy activation system according to one embodiment. This depicts the workflow to follow the iterative IPA (Integrate, Predict, Act) cycle for optimized climate response.

First, the data integration phase collects and ingests varied emissions, temperature, fossil fuel usage, and other climate data feeds. Robust ETL (extract, transform, load) processes extract data from sensors, satellites, repositories and more, clean and transform into standardized formats, and load into the unifying data store. This integrates heterogeneous data sets into a consolidated foundation.

Next, the predictive analytics phase applies machine learning algorithms trained on the aggregated climate data corpus to generate forecasts. Models predict expected temperature changes, emissions trends, and extreme weather events based on current trajectories. Continual retraining tunes model accuracy.

Key performance indicators are then identified to quantify sustainability metrics like greenhouse gas levels, renewable energy adoption, etc. These KPIs enable tracking progress versus climate goals. Problematic locations are highlighted for priority action based on emission hotspots, warming trends etc.

The system then collaborates with relevant authorities in designated regions to enact recycling programs, emissions reduction initiatives, and other interventions to improve sustainability KPIs. Formalizing robust recycling ecosystems supports a circular economy.

Next, the platform designs award systems to incentivize climate action based on the KPI metrics. For instance, municipalities can receive funding for improving recycling levels and lowering community emissions versus benchmarks. This catalyzes participation.

Finally, the integrated platform combines data ingestion, analytics, collaboration tools, and incentive design to activate an end-to-end climate response program. The iterative workflow allows recurring tuning of the IPA cycle components for continuous enhancement. This systems approach enables comprehensive technology-enabled climate governance.

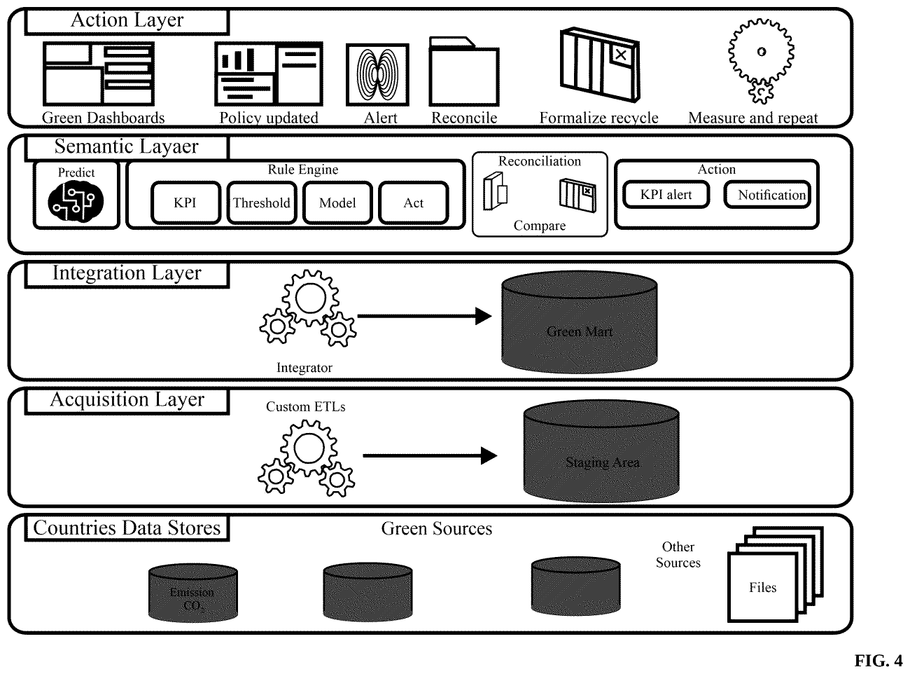

On the other hand, FIG. 4 illustrates a process to achieve a sustainable climate control system according to one embodiment. The climate data analytics and policy activation platform follows a layered workflow to enable technology-driven sustainability governance.

First, the system ingests raw climate data feeds from distributed sources like sensors, satellites, databases, and more. This includes emission levels, temperature readings, fossil fuel usage, and other metrics collected from countries, cities, and regions worldwide. Since data formats vary, robust ETL (extract, transform, load) processes standardize the aggregation.

The acquisition layer employs ETL techniques to pull the heterogeneous data, clean and process it into uniform schemas, and load into staging repositories. This structures the data for integration.

The integration layer then combines the disparate datasets into a unified data store. APIs, adapters, and mapping functions amalgamate the myriad data streams into one cohesive data corpus for a consolidated 360-degree view. This climate data mart facilitates cross-domain analysis.

The semantic layer leverages analytical engines on the integrated data to gain actionable insights. The prediction engine uses AI algorithms to forecast emission trends, temperature changes, and extreme weather events based on projections. The rule engine quantifies sustainability KPIs for tracking by applying defined formulas to the predictive outputs.

The reconciliation engine compares previous predictions to actual metrics once available, re-tuning the models to enhance accuracy over time. The action engine then surfaces alerts and notifications when intervention is required based on the data-driven insights.

Next, the action layer translates the predictive intelligence into real-world climate actions. Interactive dashboards visualize trends through charts, maps, and graphs. Policy tracker tools assess the outcomes of different sustainability initiatives and regulations. Alerts notify administrators of critical thresholds breached.

Together, these features allow governments, businesses, and communities to enact data-driven policies, programs, and interventions to mitigate climate change risks. The layers work synergistically to ingest disparate data, integrate into a unified structure, analyze using AI to gain insights, and activate targeted evidence-based responses—enabling a sustainable climate governance platform.

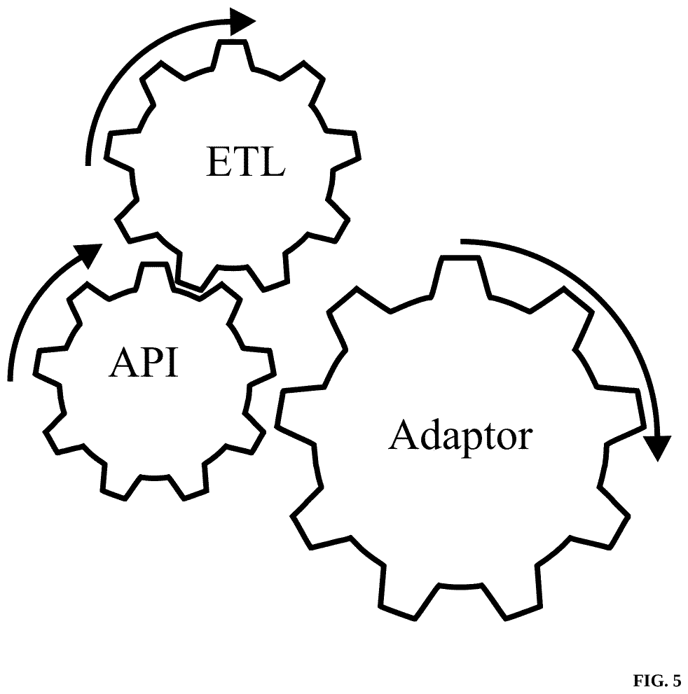

The FIG. 5 illustrates a universal adapter design for the climate data analytics system according to one embodiment. This allows integrating diverse data sources in a standardized way for flexible and scalable data ingestion.

A key challenge is dealing with heterogeneous data formats from all the regions providing inputs to the platform. These encompass structured sources like databases as well as unstructured data from sensors, satellites, and more. The adapter abstraction layer handles this complexity.

The universal adapter makes the system highly adaptable to any new data feed using common ETL constructs. Extract, transform, and load workflows are leveraged to pull data, process and convert to target schemas, and populate the stage tables. This decouples the backend data integration from the input specifics.

Climate change metrics captured include emissions, temperature, fossil fuel usage, ocean levels, deforestation, and more. These are stored in fact and dimension tables for analysis. Source-agnostic mapping functions load the data into predefined staging structures, avoiding reliance on input format details.

The adapter provides a consistent loading mechanism from sources like weather agency databases, municipal record systems, and sensor timeseries repositories. It extracts the data, applies any required transformations, and populates universal stage tables. Incremental ETL jobs then load into the refined analytics data store.

This approach removes dependencies on input data schemas. All staging tables use the same predefined canonical structure. The grain and integrity constraints are standardized regardless of data provider variations. This common intermediary layer enables integrating any number of region-specific data feeds in a scalable manner.

The adapters implement interfaces providing options for push or pull models. For legacy systems without API access, file loads are supported using batch transfer. The components include a universal API for live connectivity along with file-based transfer capabilities. By using standardized interfaces and transformations on the way into the refined zone, the system achieves flexibility in the face of heterogeneous data. This universal adapter pattern is critical for aggregating diverse climate metrics in a unified way—enabling advanced analytics across the aggregated knowledge-base.

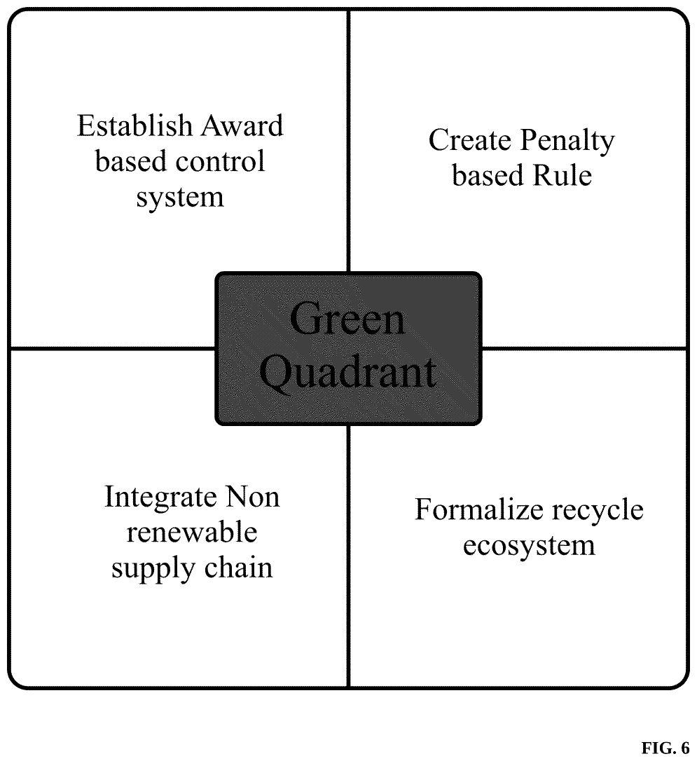

The illustrative embodiment of FIG. 6 demonstrates a four-quadrant model for sustainable climate governance according to one embodiment. It delineates an approach across integration, formalization, administration, and incentivization to drive comprehensive transformation.

Quadrant 1 focuses on integrating non-renewable energy supply chains. It involves mapping out current fossil fuel usage flows—from extraction, processing, power generation, distribution, and consumption. Understanding the end-to-end chains provides visibility to identify transition points that can shift to renewable sources like solar, wind, geothermal, and hydrogen. Data integration underpins tracking resource flows across the lifecycle.

Quadrant 2 centers on formalizing recycling ecosystems to enable a circular economy. Currently, solid waste management remains informal in many regions, with only 10% formally processed. The remainder ends up incinerated or in landfills, representing lost economic value and uncontrolled emissions. Contamination from unmanaged waste also increasingly imperils oceans and other natural carbon sinks.

Formalizing recycling ecosystems creates opportunities to capture value, reduce leakage, and minimize harmful byproducts. For instance, implementing integrated waste-to-energy systems allows converting plastics, paper, and organic matter into electricity, fuels, and fertilizers instead of release into the environment. Data enables optimizing these material flows.

Quadrant 3 focuses on administrative levers like penalties and emission scoring to motivate behavioral change. Despite climate awareness, short-term economic and political motives often supersede. Top-down mechanisms like carbon pricing and emissions-based trade controls can counteract these forces.

For example, higher carbon taxes and import tariffs can apply to regions and nations with excessive emissions versus benchmarks. An “environmental credit score” system based on sustainability KPIs can regulate access to beneficial programs and resources. These motivators make environmental impact a determinant of economic advantage.

Finally, Quadrant 4 represents incentives like subsidies and awards to encourage grassroots action. If penalties are in place, communities making progress on sustainability metrics can receive commensurate benefits. For instance, municipalities with high recycling rates may get discounts on finished goods made from their recycled materials. This engenders local participation and momentum. Together, the four quadrants provide a framework for technology-enabled climate governance spanning top-down policy mandates as well as bottom-up incentives. Data integration, analytics, and action form the foundation to activate and optimize these mechanisms systematically—driving society-wide transformation.

The variations in data sources, analytical models, visualization formats, and policy activation pathways provide governments, businesses, and communities with the flexibility to implement climate action plans aligned with their specific sustainability goals and capabilities. Additionally, the integrated platform can be customized to meet localized requirements, allowing for unique implementations tailored to the needs of cities, regions, or nations. With its ability to synthesize complex environmental data into actionable intelligence, this invention creates an invaluable decision-support system for evidence-based climate governance and mitigation.

An important capability of the integrated analytics platform is enabling data-driven strategies to accelerate adoption of technologies that reduce fossil fuel usage and associated emissions. This entails identifying high-impact intervention points based on rigorous assessment of mobility patterns, energy demands, infrastructure availability and other factors.

For electric vehicles (EVs), the system can model consumer driving needs, map this against charging infrastructure locations, analyze grid capacity for incremental renewable energy supply, and quantify expected CO2 savings. Granular analytics at city, state and national levels reveal prioritized opportunities for EV ecosystem enhancement through financial incentives, new charging station build-outs, and consumer education.

Interactive visualizations empower policymakers to simulate EV adoption trajectories based on different policy levers, pinpointing optimal combinations for sustainability and consumer affordability. Location-specific insights even enable targeted interventions by identifying emission reduction “hot spots”—which neighborhoods or popular routes will yield the greatest impact.

Similarly for clean energy technology, whether solar, wind, geothermal or other sources, the analytics engine prescribes tailored expansion roadmaps. Predictive modeling reveals supply-demand gaps across sources and regions, quantifies emission offsets, and simulates required investments. This intelligence helps optimize funding allocation for new renewable projects, transmission infrastructure, and retrofits to achieve climate goals.

As such, the system delivers integrated analytics encompassing usage patterns, infrastructure mapping, capacity planning, investment modeling and regulatory scenario evaluations. The multi-dimensional insights accelerate data-driven decision making on priority interventions—where to invest, which policy tools to activate, how to educate consumers—to smooth the transition to wider sustainable technology adoption in transportation, electricity production and consumption across sectors. With robust analytics illumination systemic linkages and trade-offs, rapid strides toward national and global emission reduction targets become achievable.

The specification provides comprehensive technical guidance regarding the architecture, components, and workflows utilized in the design of the integrated platform. Data engineers, climate analysts, and sustainability policy experts can rely on the detailed descriptions and accompanying figures to develop and deploy customized implementations of the disclosed system. The interplay of real-time data, predictive analytics, and policy activation modules creates an adaptive framework that enhances the ability of diverse entities to understand, anticipate, and respond to pressing climate change challenges.

It is important to note that the invention is intended to embrace all alternatives, modifications, equivalents and variations that are within the spirit and scope of the disclosed subject matter.

The flexible, modular architecture ensures that the platform can be deployed across a variety of technological environments and use cases. Additionally, the system can integrate with different applications and devices, and provides configuration options to match users' specific climate information and policy development needs.

### INDUSTRIAL APPLICATION

The present invention has broad applicability across industries and public sector organizations seeking to leverage data science for enhanced sustainability and climate change mitigation. It provides an integrated platform to consolidate, analyze, and activate on environmental data for major industrial players in energy, transportation, manufacturing, oil and gas, and other climate-impacting sectors. The predictive capabilities enabled by advanced AI and machine learning models provide data-driven insights to inform sustainability planning and investments. Overall, the system delivers a powerful climate governance toolkit for enterprises, governments, and communities striving for improved environmental performance and climate resilience.

What is claimed is:

1. A system for climate change mitigation through integrated data analytics and policy activation, comprising:
a data consolidation module configured to ingest emissions data from a plurality of sources and integrate the data into a unified structure;
an analytics engine configured to apply one or more machine learning algorithms on the consolidated data to generate predictive insights;
a policy activation module configured to translate the predictive insights into one or more sustainability policies and climate actions; and
a user interface configured to display the predictive insights and recommended sustainability policies and climate actions.

2. The system of claim 1, wherein the data consolidation module employs ETL (extract, transform, load) processes to standardize the ingested emissions data.

3. The system of claim 1, wherein the analytics engine includes pre-trained machine learning models for forecasting greenhouse gas emissions trends and climate change impacts.

4. The system of claim 1, wherein the policy activation module includes a scenario analysis tool for simulating sustainability policy outcomes.

5. The system of claim 1, wherein the user interface includes interactive visualizations and alerts based on the predictive insights.

6. A computer program product for climate change mitigation through integrated data analytics and policy activation, the computer program product comprising a non-transitory computer-readable medium storing instructions executable by a processor to:
consolidate emissions data from a plurality of sources into a unified structure;
analyze the consolidated emissions data using one or more machine learning techniques to generate predictive insights;
translate the predictive insights into recommended sustainability policies and climate actions; and
display the recommended sustainability policies and climate actions to a user.

7. The computer program product of claim 6, wherein the instructions to consolidate the emissions data include ETL (extract, transform, load) procedures for data ingestion and standardization.

8. The computer program product of claim 6, further comprising instructions to train and apply machine learning models to forecast greenhouse gas emissions trends and climate change impacts.

9. The computer program product of claim 6, further comprising instructions to run simulations of sustainability policy scenarios based on the predictive insights.

10. The computer program product of claim 6, further comprising instructions to generate interactive visualizations and alerts representing the predictive insights for display.

11. A computer-implemented method for climate change mitigation through integrated data analytics and policy activation, the method comprising:
ingesting emissions data from a plurality of sources;
standardizing the ingested emissions data into a unified structure;
applying one or more machine learning techniques to the standardized data to generate predictive insights;
translating the predictive insights into recommended sustainability policies and climate actions; and
displaying the recommended sustainability policies and climate actions to a user.

12. The computer-implemented method of claim 11, wherein ingesting the emissions data comprises extracting, transforming, and loading the data using ETL procedures.

13. The computer-implemented method of claim 11, wherein applying one or more machine learning techniques comprises training and applying models to forecast greenhouse gas emissions trends and climate change impacts.

14. The computer-implemented method of claim 11, further comprising running simulations of sustainability policy scenarios based on the predictive insights.

15. The computer-implemented method of claim 11, wherein displaying the recommended sustainability policies and climate actions comprises generating interactive visualizations and alerts representing the predictive insights.
